(19) United States
(12) Patent Application Publication
(10) Pub. No.: US 2002/0152396 A1
(43) Pub. Date: Oct. 17, 2002

(54) Method for secure restoration of a database stroring non-secure content

(76) Inventors: Michael S. Fox, Chandler, AZ (US); Keith L. Shippy, Tempe, AZ (US); Thomas J. Brown, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/834,084

(22) Filed: Apr. 11, 2001

(51) Int. Cl. H04L 9/32; G06F 12/16

(52) U.S. Cl. 713/200

(57) ABSTRACT

Deterring a rollback attack against a first database by determining if the first database is corrupted, the first database being associated with a first authentication code, determining if a second database is corrupted when the first database is corrupted, the second database being associated with a second authentication code, the second database having contents substantially the same as the first database, and when the second database is not corrupted, recalculating the second authentication code using a portion of the first authentication code, copying the second database over the first database, and proceeding with authorized operations for processing content by an application program.

### BACKGROUND

1. Field

The present invention relates generally to controlling access to digital content in computer and consumer electronics systems and, more specifically, to protecting non-secured content in a database from rollback attacks.

2. Description

The personal computer (PC) platform is inherently an open and accessible computer architecture. However, the openness of the PC means that it is a fundamentally insecure computing platform. Both the hardware and software can be accessed for observation and modification. This openness allows malicious users and programs to observe and to modify executing code, perhaps with the aid of software tools such as debuggers and system diagnostic tools. Despite these risks, there are classes of operations that must be performed securely on the fundamentally insecure PC platform. These are applications where the basic integrity of the operation must be assumed, or at least verified, to be reliable. Examples of such operations include financial transactions and other electronic commerce, unattended access authorization, and digital content protection and management.

For content providers, countering the threat of digital piracy on the PC requires new software that is resistant to attacks by a malicious user. In this scenario, the malicious user may wish to tamper with or replace particular components of the software in order to gain unauthorized access to digital content or to make unauthorized reproductions. A cryptosystem based on cryptographic methods employed in conjunction with the software may be used to help protect the content owner's rights. Content may be encrypted to provide some measure of protection, but the software accessing the decrypted content during playback is still vulnerable to attack.

Further complicating the content protection scenario for music content is the rising use of portable digital music players. A portable music player (also known as a portable device (PD)) may be coupled to a PC to obtain digital music files. FIG. 1 illustrates a typical known configuration for accessing such content. Content 10 stored on a storage medium may be input to a computer system 12. An application program 14 on the computer system (e.g., a “ripper”) may be used to extract the content. When the content is audio data such as music, the application may convert the input data into the well-known Moving Pictures Expert Group (MPEG) level 3 (MP3) format 16. Once converted to the MP3 format, the content may be stored as an MP3 file 18 on long-term storage 20 of the computer system (such as a hard disk, for example). Subsequently, the MP3 data may be transferred into a portable device 22 for rendering to a user.

Absent an effective content protection scheme, these files may also be easily copied and transferred to others, usually without the authorization of the content owners. In order to promote the protection of such music files when used with portable devices and PCs, the Secure Digital Music Initiative (SDMI) was formed to specify requirements for content protection implementations. SDMI is a forum to develop open technology specifications that protect the playing, storing, and distributing of digital music.

The SDMI Portable Device Specification (Part 1, Revision 1.0, Jul. 8, 1999, PDWD, available on the Internet at http://www.sdmi.org) contains functional requirements for portable devices and associated applications, thereby providing a protected environment for digital audio content. According to the Portable Device Specification, a portable device (PD) is a device that stores, on internal or portable media, SDMI protected content. The Specification requires that any content intended for use in an SDMI PD be protected at all times after it first gets imported into an SDMI application or recorded onto an SDMI PD. Subsequent storage, use within, or transfer between SDMI applications or PDs must be done in a manner that protects the content. The Specification also dictates that unprotected or unencrypted music that is imported to an SDMI-compliant computer system or portable device must pass a security test called a watermark screen. A watermark is a data pattern embedded in the content used for security purposes that is typically not perceivable by a user during rendering of the content. The purpose of watermark screening is to detect illegitimately distributed music. Based on whether or not a valid watermark is found in the content, certain rules for copying that content must be enforced by the SDMI-compliant system. If a SDMI-compliant system stores such content on the PC, these rules must be enforced beginning from the time the content was imported to the local storage of the PC (e.g., the hard disk) up to and through the time that the content is encrypted and “checked out” or copied to a SDMI-compliant portable device (such as a portable music player).

The copy information used to deter unauthorized copying of the content may be stored in a database on the PC. Despite the added level of security intended by SDMI-compliant devices, this database may still be vulnerable to attack.

### BRIEF DESCRIPTION OF THE DRAWINGS

The features and advantages of the present invention will become apparent from the following detailed description of the present invention in which:

FIG. 1 is a diagram of a known system architecture for obtaining and rendering content on a portable device (Prior Art);

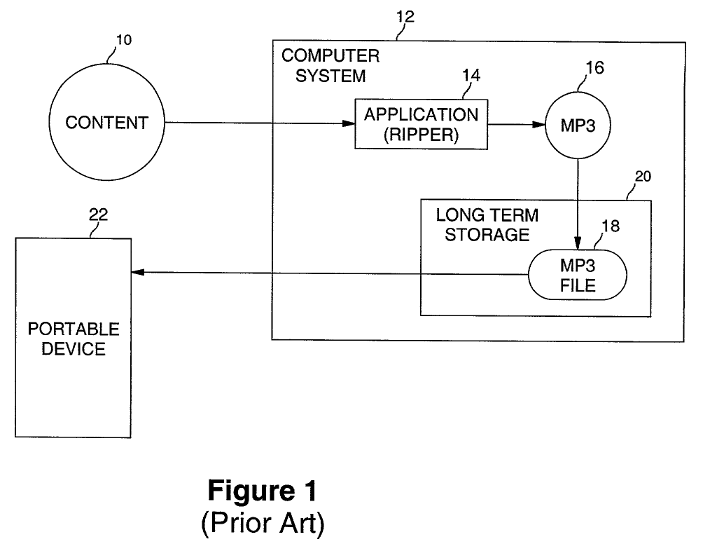

FIG. 2 is a diagram of a system architecture for obtaining and rendering content on a portable device according to an embodiment of the present invention;

FIG. 3 is a diagram illustrating message authentication codes (MACs) associated with a primary control database and a backup control database according to an embodiment of the present invention; and

FIG. 4 is a flow diagram of secure restore processing according to an embodiment of the present invention.

### DETAILED DESCRIPTION

An embodiment of the present invention is a method of securely restoring a database used for storing unsecured content. In one embodiment, the database may be used to maintain usage rights for digital content. The usage rights may be compliant with SDMI requirements in some embodiments. The usage rights may include copy control information. Each time a user desires to make a copy of selected content (for example, to download the content from a computer system, such as a PC, to a portable device), an entry in a control database for that content may be decremented (or otherwise updated) to signify that the number of copies that the user may be authorized to make is now one less than before.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

Although digital rights management schemes are generally helpful for controlling access to digital content, some systems may negatively affect the user's experience in interacting with their PC and PDs. One capability that is typically desired by users is a mechanism for allowing users to backup and restore a database while ensuring that the contents of the database have not been modified. This would allow a user to upgrade components of their computer (e.g., hard disk drive) without rendering the database useless.

However, such a capability may allow some users to mount “rollback” attacks to circumvent a content protection scheme. For example, a user could save a backup of a copy control database file prior to downloading selected content to a PD or prior to copying the content within a PC. During the download or copy operation, application software supporting a content protection scheme (e.g., SDMI implementations) may decrement the copy control count, thereby reflecting the change in usage status. After completing the download or copy operation, the user could simply restore the original copy control database that was backed up before the download session, thus easily defeating the management of the copy control count. Hence, a new way of providing backup and restore capabilities that still supports a content protection scheme is needed. The backup and restore process must deter users from continuously restoring old databases to circumvent copy protection mechanisms.

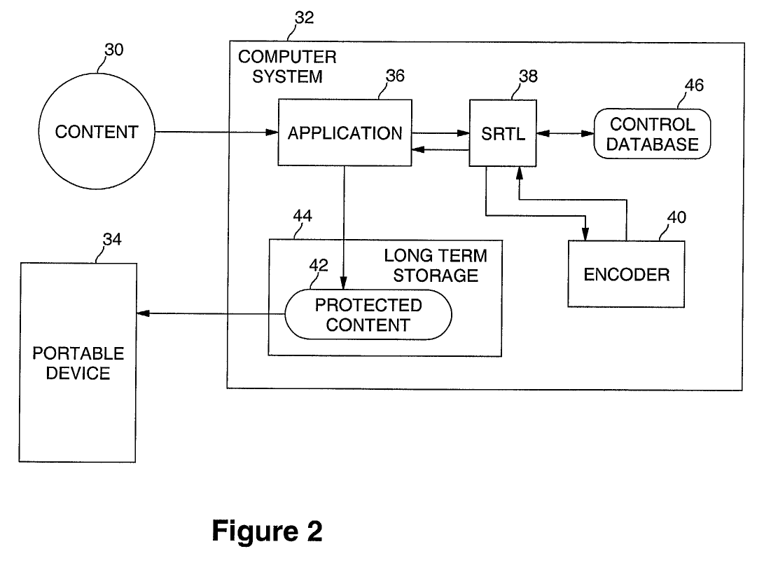

FIG. 2 is a diagram of a system architecture for obtaining and rendering content on a portable device (PD) according to an embodiment of the present invention. In this system, content 30 may be obtained from a storage medium by computer system 32 (such as a PC), converted into a different format, and downloaded to PD 34. A PD comprises a device that stores, on internal or portable media, protected or unprotected content received from a client platform, such as a PC.

Some embodiments of the present invention are consistent with various requirements of the SDMI Portable Device Specification (Part 1, Revision 1.0, Jul. 8, 1999, PDWD, available on the Internet at http://www.sdmi.org), although embodiments of the invention may also be implemented consistent with other system architectures or specifications, without limiting the scope of the invention. The SDMI PD Specification is based on the premise that the rights of those who create content should be respected, and that acceptance of those rights provides the basis for allowing consumers to access content, including music, in new ways. Under the specification, users can copy (or “rip”) songs from their CDs onto their own PCs or PDs. In the architecture shown in FIG. 2, application program 36 may be a music player or music jukebox software application that obtains content and renders the content for a user. Application 36 may perform a content acquisition task such as “ripping” music data from a compact disc (CD) in linear pulse code modulated (LPCM) format. The application program interacts with secure run-time layer (SRTL) software 38 to control the encoding of the data into MP3 data by encoder 40. In some embodiments, the SRTL “plugs in” or otherwise is coupled to the application program to provide SDMI compliance. The SRTL receives the encoded MP3 data from encoder 40 and encrypts it to deter unauthorized access to the content. The resulting protected content 42 may be stored in long-term storage 44 (e.g., a hard disk drive) by the application. The protected content may then be subsequently downloaded to the PD 34 if the usage rules for the content allow the transfer. The PD also receives cryptographic keys needed for decrypting the protected content prior to rendering on the PD.

Under SDMI rules, four copies may be made each time the CD is copied and stored in a local SDMI format (e.g., protected content) and/or on PDs or portable storage media, with three of those copies being allowed for PDs or portable media (PM). If more copies are needed, the original content source (e.g., CD, or other legacy format) can be copied again. The process of copying must include the binding of the content to a local context (e.g., a PC, PD or PM). The specification also includes rules for “check in/check out” procedures that can be used to allow a consumer to maintain libraries of protected content on a PC and then “check out” those copies to one or more PDs. Check out is the process by which the ability to render protected content is copied and bound to a single other location and the number of permitted copies is decremented by one. Check in is the process by which the ability to render protected content is restored to its original location and the number of allowed copies is incremented by one. Usage rules are rules expressed by content providers that govern the use of content. For example, usage rules may include rules governing the number of copies/generations of copies permitted and check-in/check-out parameters (including the number of usable copies). Usage rules may be embedded, attached and/or associated with content in a protected manner.

Unprotected content is any digital content obtained from a content source 30 that is not encrypted for security purposes. Protected content as used herein is content that exhibits one or more of the following attributes. It may be encrypted, authorized for distribution by the content owner or via usage rules, has usage rules embedded, associated (either implicitly or explicitly) and/or attached in a protected manner, may be watermarked, or may be traceable back to a unique distributor (e.g., by a digital signature, watermark, or other means). Storage 44 represents any type of memory that may be used for protected content 42. For example, local storage may be a hard disk, a floppy disk, a random access memory (RAM), flash memory (including SD cards, memory sticks, and the like), or other storage device. In one embodiment, local storage may comprise a part of a computer system 32, such as a PC or a workstation. In the context of audio data, content 30 may comprise individual digital audio titles, such as songs, collections of songs, or spoken word recordings, with one or more titles per file. Content may include digital audio and related data (e.g., text, graphics, video, and metadata).

To support the above described architecture, control database 46 may be used to store usage rules (e.g., copy control counts) and cryptographic keys for encrypting the content. The control database must be protected from rollback attacks, otherwise a user could simply backup and restore the control database at will to circumvent the content protection scheme. The system should allow backup and restore operations for valid purposes, but not let users “hack” into the usage rules or otherwise circumvent the protection scheme.

In at least one embodiment of the present invention, at least three databases may be employed. The first database may be called a primary database. The primary database stores the usage rules and keys as discussed above in relation to control database 46 (in effect, the primary database is the control database). The second database may be called a shadow database. The shadow database is a bit for bit copy of the primary database. While the application is executing, the primary database is open and being accessed. The changes made to the primary database (which may be stored in the RAM of the computer system), however, may be committed to the shadow database stored on the long-term storage of the computer system. It is intended that the contents of the primary database and the shadow database remain substantially equivalent. The shadow control database may be used in the event the primary control database becomes corrupted due to a computer system error during execution of the application. The third database may be called a backup database. Each time the application is launched, the state of the primary database prior to any new user activity may be saved in the backup database. The application then may be run, but changes made to the primary database may not be reflected in the backup database until the beginning of the next session (i.e., when the application is launched again). Immediately after launch of the application and the saving of the primary control database as the backup control database, the primary control database is substantially the same as the backup control database. As other processing continues, the contents of the control databases may diverge until the re-launch of the application.

A first step to solve the rollback attack problem is to determine if the primary control database has been tampered with or corrupted between sessions of running the application program 36. This may be accomplished in one embodiment by using at least one message authentication code (MAC). A MAC may consist of a one-way hash of all of the data in the primary control database concatenated with a secret that prevents hackers from duplicating the hash (and possibly some other elements, depending on the desired level of security). The secret may be any predetermined value. In other embodiments, other data may be used in computation of the MAC, and the invention is not limited in this respect. The MAC may be hidden somewhere in the memory of the computer system 32. Each time the application program starts up, the MAC of the primary control database may be calculated and compared with the hidden MAC stored previously (e.g., at the end of the previous session of running the application program). If the two MACs are equivalent, the data in the database may be assumed to be valid and not modified. Otherwise, the database may be considered to be corrupted.

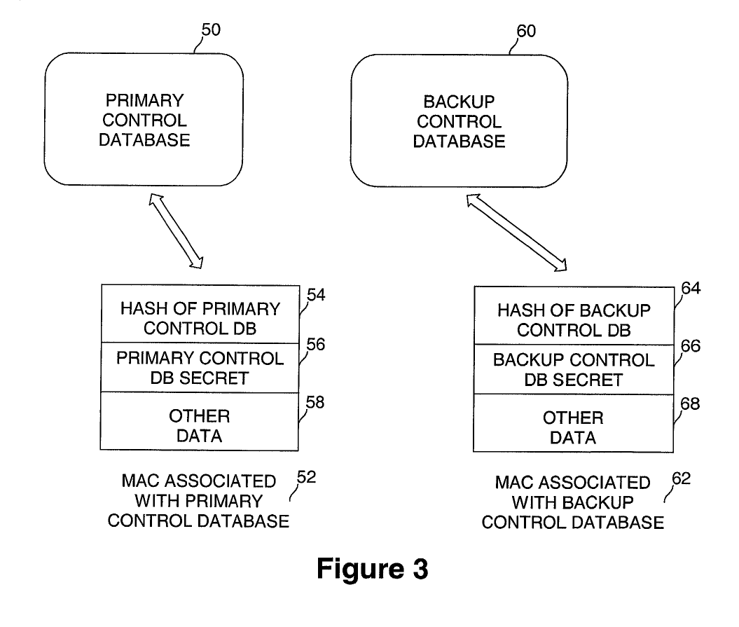

Once it is determined that the primary control database is not corrupted at start up time for the application, the backup control database may be created. A MAC for the backup control database may also be created and stored. One difference between the primary control database and the backup control database is that the MAC of the backup control database may be calculated using a different secret than the MAC of the primary control database. This prevents a user from simply renaming the backup control database as the primary control database to return the control database to a previous state (after changes have been made to the copy information during a session of the application program). FIG. 3 illustrates this difference. As shown in FIG. 3, the primary control database 50 may be associated with a MAC 52. The MAC associated with the primary control database may include a hash of portions of or all of the primary control database 54, a primary control database (DB) secret 56, and possibly other data 58. The backup control database 60 may be associated with a MAC 62. The MAC associated with the backup control database may include a hash of portions of or all of the backup control database 64, a backup control DB secret 66, and possibly other data 68. Note that at startup time for each session of the application program, the backup control database may be created to be an exact duplicate of the primary control database.

If it is determined that the primary control database is corrupted or can no longer be used for whatever reason, the backup control database may be restored and used as the new primary control database. In order to do this securely, the application may present a challenge code to the user via a user interface mechanism. For example, the user may then go to a web site and enter the challenge code, or place a telephone call to a customer support center supplying the code, or use any other “out of band” mechanism. In this way, some central authority (e.g., the distributor of the control database or the content owner) has the secret necessary to validate the user's challenge code. Based on the challenge code and the distributor's secret, a passcode may be provided back to the user to allow the restore process to continue. The passcode may be entered into the application program to continue processing.

At this point, the MAC of the backup control database may be recomputed using the primary control database secret and the backup control database may be copied over the primary control database. By requiring the user to interact with a website, customer support center, or other out of band mechanism (e.g., electronic mail message exchange), the content distributor or owner may track and/or control how many times the user has restored the control database. Thus, unauthorized use of the backup/restore capability may be deterred.

In at least one embodiment, the system may be modified to allow a user to complete an arbitrary number of restores of the control database before requiring the user to enter a passcode. To accomplish this, a restore count may be stored in the primary control database file. The restore count may be decremented each time a restore is performed. Once the restore count reaches zero, the challenge code may be presented to the user and a passcode may be required to continue the restore operation. An attacker may not simply modify the restore count undetected because of the MACs associated with the control databases. If the restore count is tampered with, the MAC of the control database will change and thus will not match the hidden MAC previously stored.

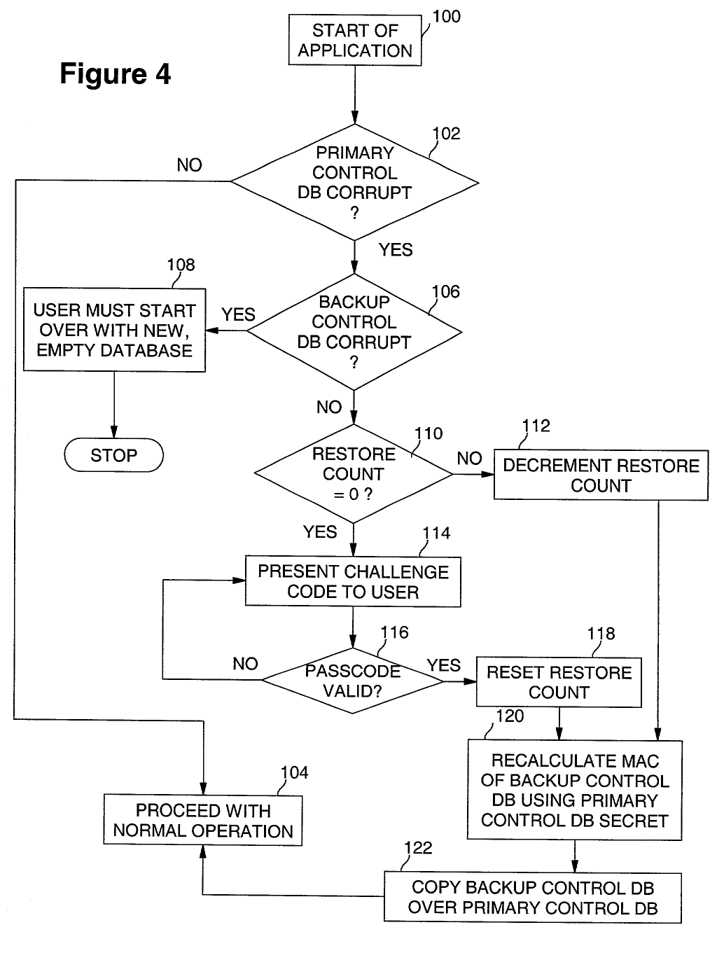

FIG. 4 is a flow diagram of secure restore processing according to an embodiment of the present invention. At block 100, the application program may be started. At block 102, it may be determined if the primary control database is corrupt. If the primary control database is not corrupt, then processing continues with normal, authorized operations of the application program at block 104. Otherwise, if the primary control database is corrupted, then it may be determined if the backup control database is corrupted at block 106. If the backup control database is corrupted, then processing continues with block 108.

At block 108, the user must start over with a new, empty primary control database. All previous activity and usage rules may be lost. Processing stops until a reload or reauthorization of the application program occurs. If the backup control database is not corrupted, then processing continues at block 110. If the system includes a restore count feature, the restore count may be checked. If the restore count does not equal zero, then the restore count may be decrement at block 112. Otherwise, when the restore count equals zero, then a challenge code may be presented to the user at block 114. The user takes the challenge code to a distributor, content owner or other party via an out of band mechanism to obtain a passcode for continued restore operation. If the passcode is not valid at block 116, processing continues with the challenge code again at block 114. In one embodiment, the looping of this processing may be limited by a counter to cut off attempts at guessing or hacking the passcode. When a predetermined number of invalid attempts are made, the application program may be terminated. In another embodiment, a newly generated challenge code may be presented to the user each time the passcode supplied by the user is invalid.

If the passcode is valid at block 116, then the restore count may be reset at block 118. If the restore count has been reset at block 118 or properly decremented at block 112, then the MAC of the backup control database may be recalculated using the secret from the primary control database at block 120. The backup control database may then be copied over the primary control database at block 122. This resets the primary control database back to the state it existed in prior to the latest session of the application program. Processing may then continue with normal, authorized operations at block 104.

In an embodiment of the present invention wherein a restore count is not used, processing continues directly from block 106 to block 114, with processing of blocks 110, 112 and 1 18 being omitted.

By using the above-described processing, systems may deter rollback attacks on control databases used for implementing content protection, yet still allow a user to perform database restores where necessary and authorized.

The techniques described herein are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, and similar devices that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices.

Each program may be implemented in a high level procedural or object oriented programming language to communicate with a processing system. However, programs may be implemented in assembly or machine language, if desired. In any case, the language may be compiled or interpreted.

Each such program may be stored on a storage medium or device, e.g., compact read only memory (CD-ROM), digital versatile disk (DVD), hard disk, magnetic disk, or similar medium or device, that is readable by a general or special purpose programmable machine for configuring and operating the machine when the storage medium or device is read by the computer to perform the procedures described herein. The system may also be considered to be implemented as a machine-readable storage medium, configured with a program, where the storage medium so configured causes a machine to operate in a specific manner. Other embodiments are within the scope of the following claims.

In the preceding description, various aspects of the present invention have been described. For purposes of explanation, specific numbers, systems and configurations were set forth in order to provide a thorough understanding of the present invention. However, it is apparent to one skilled in the art having the benefit of this disclosure that the present invention may be practiced without the specific details. In other instances, well-known features were omitted or simplified in order not to obscure the present invention.

While this invention has been described with reference to illustrative embodiments, this description is not intended to be construed in a limiting sense. Various modifications of the illustrative embodiments, as well as other embodiments of the invention, which are apparent to persons skilled in the art to which the inventions pertains are deemed to lie within the spirit and scope of the invention.

What is claimed is:

1. A method of deterring a rollback attack against a first database comprising:
determining if the first database is corrupted, the first database being associated with a first authentication code;
determining if a second database is corrupted when the first database is corrupted, the second database being associated with a second authentication code, the second database having contents substantially the same as the first database;
when the second database is not corrupted, recalculating the second authentication code using a portion of the first authentication code, copying the second database over the first database, and proceeding with authorized operations for processing content by an application program.

2. The method of claim 1, when the second database is not corrupted, further comprising presenting a challenge code to a user of the application program, requiring the user to obtain a passcode in response to the challenge code, and determining validity of the passcode, and performing the recalculating and copying only when the passcode is valid.

3. The method of claim 1, further comprising continuing with authorized operations of the application program for processing content when the first database is not corrupted.

4. The method of claim 1, wherein the first database comprises usage rules for processing selected content by the application program, the usage rules including a copy count for the selected content.

5. The method of claim 1, wherein the content comprises digital audio data.

6. The method of claim 5, wherein the application program complies with requirements for a secure digital music initiative (SDMI) implementation.

7. The method of claim 1, wherein the first authentication code comprises a hash of the first database and a first secret, and the second authentication code comprises a hash of the second database and a second secret, the first secret being different than the second secret.

8. The method of claim 7, wherein the portion comprises the first secret.

9. The method of claim 2, further comprising allowing a predetermined number of operations of copying the second database over the first database without presenting a challenge code to the user, requiring the user to obtain the passcode, and determining the validity of the passcode.

10. An article comprising: a storage medium having a plurality of machine readable instructions, wherein when the instructions are executed by a processor, the instructions provide for deterring a rollback attack against a first database by determining if the first database is corrupted, the first database being associated with a first authentication code, by determining if a second database is corrupted when the first database is corrupted, the second database being associated with a second authentication code, the second database having contents substantially the same as the first database, and when the second database is not corrupted, recalculating the second authentication code using a portion of the first authentication code, copying the second database over the first database, and proceeding with authorized operations for processing content by an application program.

11. The article of claim 10, when the second database is not corrupted, further comprising instructions for presenting a challenge code to a user of the application program, for requiring the user to obtain a passcode in response to the challenge code, and for determining validity of the passcode, and for performing the recalculating and copying only when the passcode is valid.

12. The article of claim 10, further comprising instructions for continuing with authorized operations of the application program for processing content when the first database is not corrupted.

13. The article of claim 10, wherein the first database comprises usage rules for processing selected content by the application program, the usage rules including a copy count for the selected content.

14. The article of claim 10, wherein the content comprises digital audio data.

15. The article of claim 14, wherein the application program complies with requirements for a secure digital music initiative (SDMI) implementation.

16. The article of claim 10, wherein the first authentication code comprises a hash of the first database and a first secret, and the second authentication code comprises a hash of the second database and a second secret, the first secret being different than the second secret.

17. The article of claim 16, wherein the portion comprises the first secret.

18. The article of claim 11, further comprising instructions for allowing a predetermined number of operations of copying the second database over the first database without presenting a challenge code to the user, requiring the user to obtain the passcode, and determining the validity of the passcode.

19. A method of deterring circumvention of a content protection system of an application program via restoration of a first control database, the first control database being associated with the application program and including usage rules for digital audio content, comprising:
determining if the first control database is corrupted, the first control database being associated with a first message authentication code (MAC);
determining if a second control database is corrupted when the first control database is corrupted, the second control database being associated with a second message authentication code (MAC), the second control database having contents substantially the same as the first control database;
when the second control database is not corrupted, performing the following actions:
presenting a challenge code to a user of the application program;
requiring the user to obtain a passcode in response to the challenge code; and
determining validity of the passcode;
recalculating the second MAC using a portion of the first MAC and copying the second control database over the first control database when the passcode is valid; and
proceeding with authorized operations for processing the digital audio content by an application program consistent with the usage rules.

20. The method of claim 19, wherein the usage rules comprise a copy count for the digital audio content.

21. The method of claim 20, wherein the application program complies with requirements for a secure digital music initiative (SDMI) implementation.

22. The method of claim 19, wherein the first MAC comprises a hash of the first control database and a first secret, and the second MAC comprises a hash of the second control database and a second secret, the first secret being different than the second secret.

23. The method of claim 19, further comprising allowing a predetermined number of operations of copying the second control database over the first control database without presenting a challenge code to the user, requiring the user to obtain the passcode, and determining the validity of the passcode.

24. The method of claim 19, wherein copying of the second control database over the first control database is performed after beginning execution of the application program but before proceeding with authorized operations for processing the digital audio content by an application program consistent with the usage rules.

25. An article comprising: a storage medium having a plurality of machine readable instructions, wherein when the instructions are executed by a processor, the instructions provide for deterring circumvention of a content protection system of an application program via restoration of a first control database, the first control database being associated with the application a program and including usage rules for digital audio content, by
determining if the first control database is corrupted, the first control database being associated with a first message authentication code (MAC);
determining if a second control database is corrupted when the first control database is corrupted, the second control database being associated with a second message authentication code (MAC), the second control database having contents substantially the same as the first control database;
when the second control database is not corrupted, performing the following actions:
presenting a challenge code to a user of the application program;
requiring the user to obtain a passcode in response to the challenge code; and
determining validity of the passcode;
recalculating the second MAC using a portion of the first MAC and copying the second control database over the first control database when the passcode is valid; and
proceeding with authorized operations for processing the digital audio content by an application program consistent with the usage rules.

26. The article of claim 25, wherein the usage rules comprise a copy count for the digital audio content.

27. The article of claim 25, wherein the first MAC comprises a hash of the first control database and a first secret, and the second MAC comprises a hash of the second control database and a second secret, the first secret being different than the second secret.

28. The article of claim 25, further comprising instructions for allowing a predetermined number of operations of copying the second control database over the first control database without presenting a challenge code to the user, requiring the user to obtain the passcode, and determining the validity of the passcode.
